(19) United States
(12) Patent Application Publication
(10) Pub. No.: US 2025/0232153 A1
(43) Pub. Date: Jul. 17, 2025

(54) METHOD AND APPARATUS FOR DISTRIBUTED PARALLEL PROCESSING FOR LAYER OF NEURAL NETWORK

(71) Applicant: SAMSUNG ELECTRONICS CO., LTD., SUWON-SI (KR)

(72) Inventors: Hyuntae Cho, Suwon-si (KR); Seung jin Kang, Suwon-si (KR); Geonu Kim, Suwon-si (KR); Gunhee Kim, Suwon-si (KR); Byunggook Na, Suwon-si (KR); Saerom Choi, Suwon-si (KR); Yongdeok Kim, Suwon-si (KR); Heejae Kim, Suwon-si (KR)

(21) Appl. No.: 18/885,045

(22) Filed: Sep. 13, 2024

(30) Foreign Application Priority Data
Jan. 12, 2024 (KR) 10-2024-0005662

(51) Int. Cl. G06N 3/042

(52) U.S. Cl. CPC G06N 3/042

(57) ABSTRACT

A method and apparatus for distributed parallel processing for a layer of a neural network are disclosed. The method includes identifying an available resource among a plurality of computing resources, generating a partial graph from an input graph based on the available resource, performing, using the available resource, a neural network operation to the partial graph to obtain an updated partial graph, and generating an output graph based on the updated partial graph.

### CROSS-REFERENCE TO RELATED APPLICATIONS

This application is based on and claims priority under 35 U.S.C. § 119 to Korean Patent Application No. 10-2024-0005662, filed on Jan. 12, 2024, in the Korean Intellectual Property Office, the contents of which are incorporated by reference herein in their entirety.

### BACKGROUND

### 1. Field of the Invention

One or more embodiments relate to a method and apparatus for distributed parallel processing for a layer of a neural network.

### 2. Description of the Related Art

Recently, neural networks have become a cornerstone of artificial intelligence (AI) and machine learning (ML) applications, driving advancements in various fields such as image recognition, natural language processing, and autonomous systems. The neural networks require substantial computational resources due to their complex architectures and large volumes of data.

In some cases, existing processing methods of neural networks rely on centralized computing systems, which can lead to bottlenecks and inefficiencies, especially when scaling up to handle extensive datasets and deeper network layers. Therefore, there is a need in the art for systems and methods that can leverage distributed computing resources to enhance performance and scalability of network processing.

### SUMMARY

The present disclosure describes systems and methods for distributed parallel processing of neural network layers. Embodiments of the present disclosure are configured to perform an efficient processing of a graph neural network (GNN). In some cases, an available or an idle apparatus may be dynamically used for processing of the GNN. According to an embodiment, the available apparatus may be located in an environment where a plurality of computing devices are present enabling the acceleration in the computation speed of a GNN layer.

According to an aspect, there is provided a method of distributed parallel processing for a layer of a neural network, the method includes identifying an available resource among a plurality of computing resources, generating a partial graph from an input graph based on the available resource, performing, using the available resource, a neural network operation to the partial graph to obtain an updated partial graph, and generating an output graph based on the updated partial graph.

The identifying the available resource may include transmitting a protocol message for each of the plurality of computing resources in a predetermined time period and receiving a response to the protocol message corresponding to the available resource, wherein the available resource is identified based on the response.

The generating of the partial graph may include determining a number of available resources among the plurality of computing resources and partitioning the input graph based on the number of available resources to obtain the partial graph.

The input graph is partitioned into a plurality of partial graphs around a same node of the input graph.

The input graph is partitioned in a simulation space.

The generating of the partial graph may include determining a processing speed of the available resource, wherein the partial graph is generated based on the processing speed.

The generating of the output graph may include combining a plurality of partial graphs to obtain the output graph.

The method may further include identifying a subsequent available resource among the plurality of computing resources and generating a subsequent partial graph from the output graph based on the subsequent available resource.

The neural network operation may include a graph neural network (GNN) operation.

According to another aspect, there is provided an apparatus for distributed parallel processing for a layer of a neural network, the apparatus includes one or more processors, a memory, and one or more programs stored in the memory and configured to be executed by the one or more processors, in which the one or more programs are configured to identify an available resource among a plurality of computing resources, generate a partial graph from an input graph based on the available resource, perform, using the available resource, a neural network operation to the partial graph to obtain an updated partial graph, and generate an output graph based on the updated partial graph.

According to an aspect, there is provided a method that includes identifying a plurality of available resources among a plurality of computing resources, generating a plurality of partial graphs from an input graph based on the plurality of available resources, performing a neural network operation on each of the plurality of partial graphs using a corresponding available resource among the plurality of available resources, respectively, to obtain a plurality of updated partial graphs, and generating an output graph based on the plurality of updated partial graphs.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a flowchart illustrating a method of distributed parallel processing for a layer of a neural network, according to an embodiment.

FIGS. 2A and 2B are diagrams illustrating a processing process of a layer according to an embodiment.

FIG. 3 is a diagram illustrating an operating background and an operating method of an apparatus, according to an embodiment.

FIG. 4 is a diagram illustrating an example in which idle resources are used differently for each layer of an apparatus, according to an embodiment.

FIGS. 5A and 5B are diagrams illustrating an example of a molecular dynamics simulation, according to an embodiment.

FIG. 6 is a block diagram of an apparatus, according to an embodiment.

FIG. 7 is a flowchart illustrating a method of distributed parallel processing for a layer of a neural network, according to an embodiment.

FIG. 8 is a flowchart illustrating a method of distributed parallel processing based on a plurality of available resources, according to an embodiment.

### DETAILED DESCRIPTION

The present invention relates to a method and apparatus for distributed parallel processing of neural network layers. As neural networks grow in complexity, the computational demands for training and inference also increase exponentially. An embodiment of the present disclosure includes a method to distribute and parallelize the processing of individual layers of a neural network across multiple computing nodes.

Existing methods for processing neural networks may be significantly limited in terms of speed and scalability, particularly for processing of extensive and deep network architectures. As a result, such methods result in prolonged training times and suboptimal utilization of computational resources. Furthermore, existing parallel processing techniques typically distribute entire networks or complete layers across nodes, which can lead to imbalanced workloads and communication overhead. Therefore, such methods hinder the development and deployment of more advanced neural network models.

By contrast, embodiments of the present disclosure provide a system and method for distributed parallel processing of neural network layers. An embodiment of the present disclosure is configured to perform an efficient processing of a graph neural network (GNN). In some cases, an available resource of a computing device may be dynamically used for processing of the GNN. According to an embodiment, the computing device may be located in an environment where a plurality of computing devices are present enabling the acceleration in the computation speed of a GNN layer.

An embodiment of the present disclosure includes a method of distributed parallel processing for a layer of a graph neural network (GNN). In some cases, the distributed parallel processing for a layer may refer to a layer that is distributed and processed by a model parallelism method, a data parallelism method, and a graph parallelism method. In some cases, the model parallelism method refers to partitioning a model into several parts and then assigning each part to a plurality of devices for processing the model. For example, the model parallelism method may be used when the model size is large.

In some cases, the data parallelism method refers to a method of processing data in parallel. In case of the data parallelism method, a large dataset may be partitioned into a plurality of mini-batches and then the plurality of mini-batches may be assigned to a plurality of devices for processing the plurality of mini-batches. In some cases, the graph parallelism method refers to partitioning a single graph into a plurality of partial graphs and then assigning each partial graph to a plurality of devices for processing the plurality of partial graphs.

An embodiment of the present disclosure includes an apparatus for computing a layer of the neural network. In some examples, the neural network may be a GNN. An exemplary embodiment of the disclosure may be configured to perform a graph parallelism method. In some cases, the apparatus manages a device pool including a plurality of computing devices that may be used for processing the neural network. In some cases, the apparatus may identify an available resource from among the plurality of computing devices based on a specification information of the computing device to perform the parallel processing of the neural network.

According to an embodiment, the apparatus partitions a graph input to the neural network or obtained from a previous layer based on the number of idle resources. In some cases, the apparatus transmits the partitioned graph to the available resources for performing a reduced computation process. Accordingly, by transmitting the plurality of partial graphs to the available resources, embodiments are able to process the graphs in parallel and reduce computation results of the partial graphs from the available resources.

The present disclosure describes systems and methods for distributed parallel processing of neural network layers. Embodiments of the present disclosure include identifying an available resource among a plurality of computing resources. In some cases, a partial graph is generated from an input graph based on the available resources. Additionally, a neural network operation may be performed on the partial graph using the available resource to update the partial graph and generate an output graph for the layer of the neural network.

An embodiment of the present disclosure comprises identifying a plurality of available resources among a plurality of computing resources. In some cases, a plurality of partial graphs may be generated from an input graph based on the plurality of available resources. According to an embodiment, a neural network operation may be performed on each of the plurality of partial graphs using a corresponding available resource among the plurality of available resources, respectively, to obtain a plurality of updated partial graphs. In some cases, an output graph is generated based on the plurality of the updated partial graphs.

Accordingly, by dynamically using an idle apparatus for computation in each layer of the GNN, embodiments of the present disclosure are able to significantly reduce the amount of computations performed for each layer. Additionally, a computation speed of the GNN layer is accelerated. In some cases, embodiments are able to substantially improve computational efficiency, reduce training times, and enable the handling of large and sophisticated neural network models.

Hereinafter, embodiments will be described in detail with reference to the accompanying drawings. However, various alterations and modifications may be made to the embodiments. Here, the embodiments are not construed as limited to the disclosure. The embodiments should be understood to include all changes, equivalents, and replacements within the idea and the technical scope of the disclosure.

The terminology used herein is for the purpose of describing particular embodiments only and is not to be limiting of the embodiments. The singular forms “a,” “an,” and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms including technical and scientific terms used herein have the same meaning as commonly understood by one of ordinary skill in the art to which the embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

When describing the embodiments with reference to the accompanying drawings, like reference numerals refer to like components and a repeated description related thereto will be omitted. In the description of embodiments, detailed description of well-known related structures or functions will be omitted when it is deemed that such description will cause ambiguous interpretation of the present disclosure.

Also, in the description of the components, terms such as first, second, A, B, (a), (b) or the like may be used herein when describing components of the present disclosure. These terms are used only for the purpose of discriminating one constituent element from another constituent element, and the nature, the sequences, or the orders of the constituent elements are not limited by the terms. When one component is described as being “connected”, “coupled”, or “attached” to another component, it should be understood that one component may be connected or attached directly to another component, and an intervening component may also be “connected”, “coupled”, or “attached” to the components.

The same name may be used to describe an element included in the embodiments described above and an element having a common function. Unless otherwise mentioned, the descriptions on the embodiments may be applicable to the following embodiments and thus, duplicated descriptions will be omitted for conciseness.

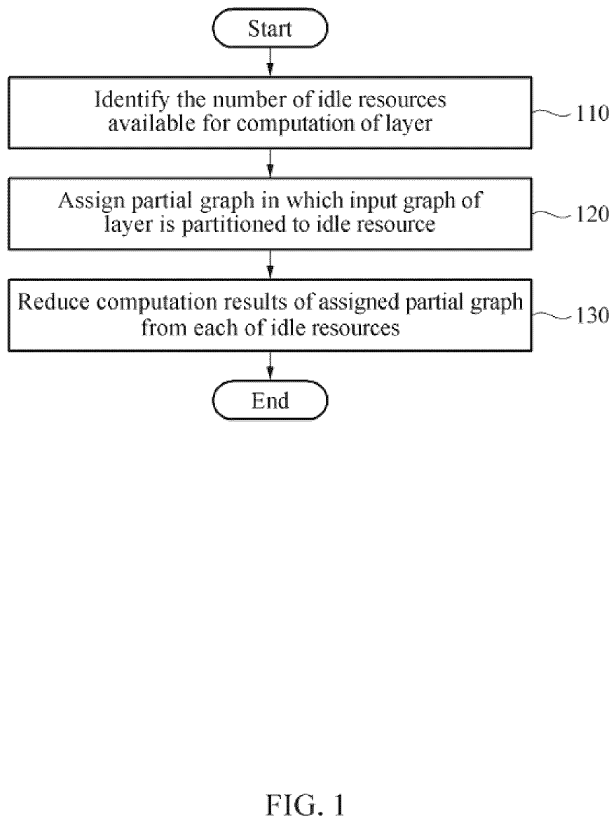

FIG. 1 is a flowchart illustrating a method of distributed parallel processing for a layer of a neural network, according to an embodiment.

Operations to be described hereinafter may be performed sequentially but not necessarily. For example, the order of the operations may change and at least two of the operations may be performed in parallel.

An apparatus (hereinafter, referred to as an “apparatus”) may compute a layer of a neural network through operations 110 to 130. The layer computed through operations 110 to 130 may correspond to one of a plurality of layers forming the neural network. Here, the neural network may correspond to a graph neural network (GNN).

Graph Neural Networks (GNNs) are a class of neural networks designed to process data structured as graphs. They operate by passing messages between nodes via edges, aggregating and transforming node features through multiple layers to capture complex relationships. GNNs use a combination of convolutional operations and pooling mechanisms tailored for graph data, enabling them to learn representations that incorporate both local and global graph structures. The models are highly effective for tasks such as node classification, link prediction, and graph classification, making them valuable in domains like social network analysis, molecular biology, and recommendation systems.

An artificial neural network (ANN) is a hardware or a software component that includes a number of connected nodes (i.e., artificial neurons), which loosely correspond to the neurons in a human brain. Each connection, or edge, transmits a signal from one node to another (like the physical synapses in a brain). When a node receives a signal, it processes the signal and then transmits the processed signal to other connected nodes. In some cases, the signals between nodes comprise real numbers, and the output of each node is computed by a function of the sum of its inputs. In some examples, nodes may determine their output using other mathematical algorithms (e.g., selecting the max from the inputs as the output) or any other suitable algorithm for activating the node. Each node and edge is associated with one or more node weights that determine how the signal is processed and transmitted.

During the training process, these weights are adjusted to improve the accuracy of the result (i.e., by minimizing a loss function which corresponds in some way to the difference between the current result and the target result). The weight of an edge increases or decreases the strength of the signal transmitted between nodes. In some cases, nodes have a threshold below which a signal is not transmitted at all. In some examples, the nodes are aggregated into layers. Different layers perform different transformations on their inputs. The initial layer is known as the input layer and the last layer is known as the output layer. In some cases, signals traverse certain layers multiple times.

In operation 110, the apparatus may identify, among computing devices, the number of idle resources available for a computation of the layer.

The apparatus may correspond to a host device that manages a device pool including a plurality of computing devices. The computing devices in the device pool may include devices for processing the neural network and devices operating for other tasks.

The apparatus may transmit a protocol message for the identification to the computing devices. In some cases, the protocol message may include information to identify the number of idle resources available for a computation of a current layer. According to an embodiment, the protocol message may have any form. In some cases, the number of computing devices to which a response of the protocol message is transmitted in a predetermined time may be identified. For example, the predetermined time may refer to a short time period, such as a time period comprising seconds or less.

In some cases, when an input graph is transmitted to the layer, the apparatus may identify available resources of the computing devices in the device pool.

In some cases, the apparatus may, in advance, include a portion of (e.g., pieces of) information related to the specification of the computing devices in the device pool. In some cases, the apparatus may identify the portions of (e.g., pieces of) specification related information through the protocol message.

In operation 120, the apparatus may assign a partial graph in which the input graph of the layer is partitioned to at least one available resource.

In some cases, the apparatus may partition the input graph based on the number of identified available resources. In some examples, when the identified number of available resources is 1, the partitioning of the input graph may be skipped.

The input graph may correspond to a computation result of a previous layer. In some cases, the input graph may be transmitted from the previous layer to the current layer being processed. In some examples, when the input graph corresponds to a first layer, the input graph may correspond to an input graph that is input to the neural network.

The input graph may be partitioned in predetermined various ways. For example, the input graph may be partitioned by randomly selecting edges according to the number of available resources.

Additionally or alternatively, the input graph may be partitioned around the same node in the input graph. In some cases, when the edges connected to each other around a node are gathered into one partial graph, the number of computations that may be processed by the computing devices may reduce. Accordingly, the number of computations may be optimized by partitioning the partial graph around the node.

In some cases, the apparatus may partition the input graph around a space (e.g., a node) when there is spatial information in a node. In some cases, when the portion of (e.g., pieces of) specification related information of the computing devices is the same, the apparatus may partition the input graph into 1/N, where N corresponds to the number of nodes. For example, a node included in a division position may be assigned to the partial graph with a high or a low number of nodes to which the edges are connected.

In some cases, when pieces of specification related information of the available resources are different, a ratio of an edge forming the partial graph may be determined based on a processing speed. In some cases, the ratio may be determined according to the portions (e.g., pieces) of specification related information. For example, a partial graph including a high number of edges may be assigned to a computing device having a fast processing speed. Additionally, for example, a partial graph including less number of edges may be assigned to a computing device having a slow processing speed. Accordingly, by considering the processing speed, the ratio of the edge may be determined such that a graph may be computed in approximately the same time using the computing devices.

The apparatus may transmit the partial graph to the computing devices for processing the partial graph. In some cases, the input graph may be processed by each computing device based on partitioning the input graph into the partial graph.

In operation 130, the apparatus may reduce computation results of the assigned partial graph from each of the available resources.

For example, the available resources may process each assigned partial graph in parallel. The available resources may process the assigned partial graph according to the specifications of the available resources and may transmit (i.e., re-transmit) the processing result to the apparatus.

The apparatus may obtain the computation results processed in each of the available resources. In some cases, the apparatus may obtain the computation results independently from each of the available resources. Additionally, the apparatus may obtain the calculation results at different timings from each of the available resources according to the computation time of the available resources. In a case when a computation is completed quickly in a certain computing device, a corresponding resource may become an available resource again and may receive commands from another apparatus.

In some cases, the apparatus may reduce the computation results from available resources. Due to the aggregation characteristics of a GNN, even when the computation results processed in parallel are summed, a result that is the same as a result processed by one apparatus may be obtained.

In some cases, the summed computation results may be transmitted to the next layer. Accordingly, the processing speed of the GNN and computing efficiency may be improved using the available resources when a computation is performed for a layer.

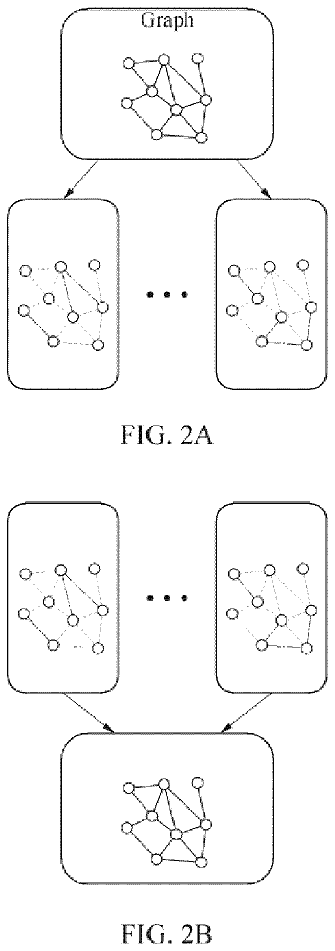

FIGS. 2A and 2B illustrate a processing method of a layer according to an embodiment.

FIG. 2A illustrates an example of partitioning a graph and FIG. 2B illustrates an example of reducing a processed graph.

A general graph G may be expressed as a node set V and an edge set E (i.e., G=(V, E)). An edge may be defined as a pair of nodes. In some cases, an edge from a node I∈V to a node j∈V may be denoted as (i, j)∈E. A kth layer of a GNN may be generally expressed as Equation 1 below.

$${e}_{ij}^{k + 1} = {ϕ}^{k} ( {x}_{i}^{k} , {x}_{j}^{k} , {e}_{ij}^{k} ) \qquad [ Equation 1 ]$$

$${x}_{i}^{k + 1} = {\sum }_{( i , j ) ∈ E} {e}_{ij}^{k + 1}$$

Here, i and j denote nodes, xᵢ^{k} denotes a node feature defined in the node i of the kth layer, and eᵢⱼ^{k} denotes an edge feature defined in an edge (i, j) connecting the node i to the node j in the kth layer. ϕ^{k} denotes a neural network in the kth layer.

When a graph is input to a neural network model, an apparatus may identify available resources for processing the graph. In some cases, the apparatus may transmit a signal to a device pool collecting and managing computing devices. In some cases, the apparatus may use the computing devices that transmit a response to the signal as the available resources. The following description is an example of assigning an equally partitioned partial graph to the available resources.

According to an embodiment, when there are N computing devices, and M available resources are identified, a partial graph Gₘ=(V, Eₘ) may be generated, where m=1, . . . , M. As shown in FIG. 2A, each partial graph may be partitioned such that the number of edges is approximately the same.

In case of an m^{th} available device, a layer may be computed for the partial graph Gₘ using Equation 1. In the m^{th} available device, when a value obtained by computing the layer is x_{i,m}^{k+1}=Σ_{(i,j)∈E}_{ₘ} eᵢⱼ^{k+1}, Equation 2 may be established.

$${x}_{i}^{k + 1} = {\sum }_{( i , j ) ϵ E} {e}_{ij}^{k + 1} = {\sum }_{m = 1}^{M} {\sum }_{( i , j ) ϵ {E}_{m}} {e}_{ij}^{k + 1} = {\sum }_{m = 1}^{M} {x}_{i , m}^{k + 1} \qquad [ Equation 2 ]$$

In some cases, as shown in FIG. 2B, a value obtained by combining (e.g., joining and/or composing and/or reducing) the computation results for the partial graph in each idle device to the apparatus and the computation results of the layer using a single apparatus may match each other. Thereafter, the computation results may be transmitted to the next layer.

In case when the computation time in the single apparatus is t_{origin}, the computation time of the layer when partitioning a graph and applying a scatter process may include t_{scatter} (i.e., t_{scatter} refers to the time for communication with the available resources), t_{compute} (i.e., t_{compute} refers to the computation time in the partial graph of the available resources), and t_{reduce} (i.e., t_{reduce} refers to the time to reduce communication from the available resources to the apparatus).

In some cases, when the amount of GNN computations in the M-partitioned partial graph is 1/M times more ideal than the amount of GNN computations in the unpartitioned graph, 1/M×t_{origin} may be t_{compute} (i.e., 1/M×t_{origin}=t_{compute}). According to an embodiment, computation acceleration may be possible when t_{origin} is greater than t_{scatter}+t_{compute}+t_{reduce} (i.e., t_{origin}>t_{scatter}+t_{compute}+t_{reduce}). In case of an ideal situation, when (M−1)/M×t_{origin} is greater than t_{scatter}+t_{reduce} (i.e., (M−1)/M×t_{origin}>t_{scatter}+t_{reduce}), that is, when the communication time is less than (M−1)/M times the computation time, the computation acceleration may be possible.

In some cases, the apparatus may identify the available computation resources for each layer, may partition the graph, and may perform a computation, such that the available computation resources may be fully utilized during GNN inference. Particularly, the apparatus may perform stable processing in an environment where available computation resources change dynamically. The method described herein may apply to data parallelism and model parallelism, which are different types of parallelism techniques.

Data parallelism is a method used in parallel computing where a large dataset is divided into mini-batches, and each of the mini-batches is processed simultaneously across multiple processors or computing units. The data parallelism approach leverages the capability of modern hardware to perform the same operation on multiple data points in parallel (e.g., at the same time), significantly speeding up the processing time. After processing, the results from each mini-batch are combined to form the final output.

Model parallelism is a technique in parallel computing where a large model is divided into smaller segments, and each segment is processed simultaneously across multiple processors or computing units. The approach is particularly useful when a model is very large to fit into the memory of a single processor. By distributing different parts of the model across multiple processors, computations can be performed concurrently, enabling the handling of larger models and improving computational efficiency. Model parallelism may be used in deep learning application, especially with very large neural networks where layers or subsets of layers are assigned to different GPUs or machines.

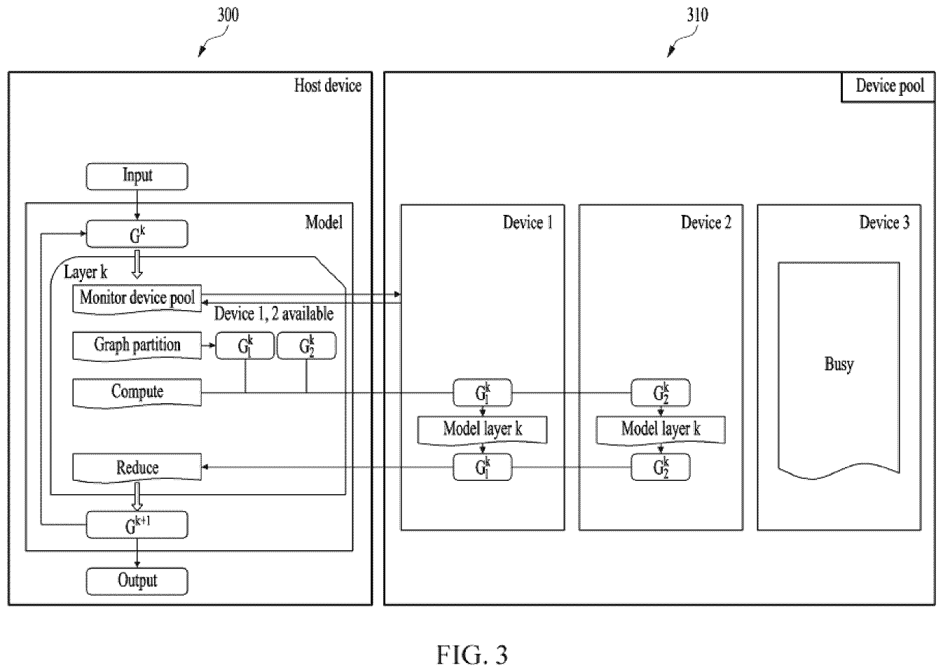

FIG. 3 illustrates an operating background and an operating method of an apparatus, according to an embodiment.

An apparatus 300 describes a method in which an available device processes a GNN in parallel in a variable environment. For example, processing a GNN in a variable environment typically refers to applying a GNN to data that changes or evolves over time, or to situations where the structure or attributes of the graph are not static. In some cases, processing a GNN in a variable environment involves designing and employing models that can effectively handle and adapt to changes in the graph's structure, attributes, or the external context in which the graph exists. The apparatus 300, among computing devices, may compute a graph by partitioning the graph into available resources using at least one computing device managed in a device pool 310.

In some cases, the graph, an initial node feature, and an edge feature may be input to an input graph. A k^{th} layer may compute the input graph by partitioning the input graph using the idle resources.

The apparatus 300 may identify the available resources in the device pool 310, i.e., device pool 310 includes a plurality of computing devices. The computing devices that transmit a response signal to a signal transmitted from the host device may be used as available resources.

As an example shown in FIG. 3, the k^{th} layer may use device 1 and device 2 as the available resources. Device 3 may be identified as being in a state in which a computation may not be performed due to the resources performing other tasks.

The apparatus 300 may partition the input graph for two available resources (e.g., device 1 and device 2). Accordingly, two partial graphs may be formed by equally partitioning the input graph based on an edge of the input graph. In some cases, two partial graphs may be formed by proportionally partitioning the input graph according to the computing ability obtained based on the specification information of the devices in the device pool 310 (e.g., device 1 and device 2).

In some cases, the two partial graphs may be assigned to the corresponding available resources (e.g., device 1 and device 2), respectively, and each apparatus (i.e., device) may compute a layer. The computation results may include a k+1^{th} feature for each partial graph.

The apparatus 300 may reduce the k+1^{th} feature computed from each available resource. In some cases, a graph feature that is input to the k+1^{th} layer may be obtained by combining (e.g., by performing a summation of) the computation results obtained from the available resources.

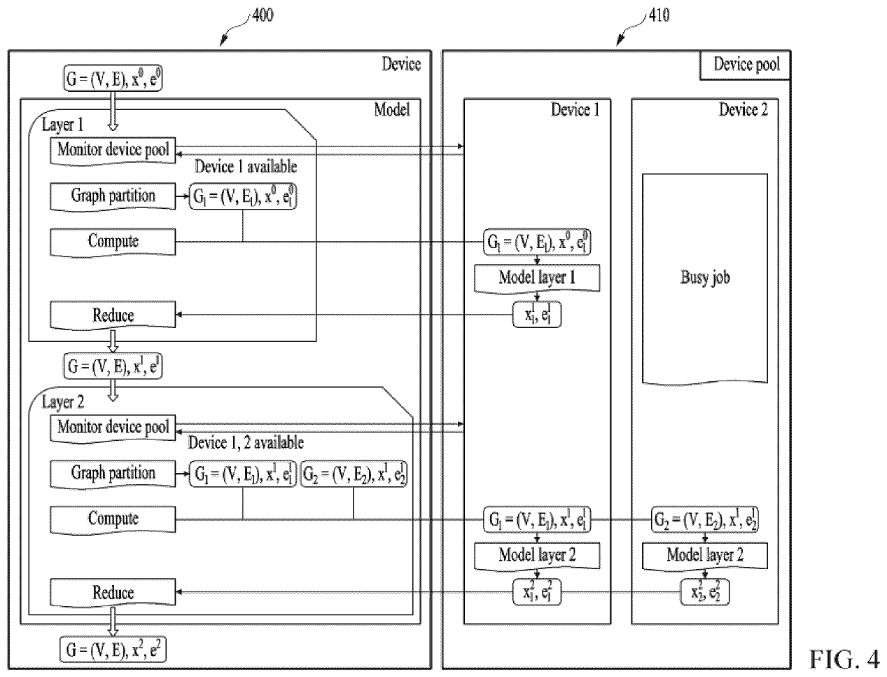

FIG. 4 illustrates an example method in which available resources are used differently for each layer of an apparatus, according to an embodiment.

FIG. 4 illustrates a situation in which an apparatus 400 infers a neural network model while other tasks are in progress on device 2. As an example shown in FIG. 4, device pool 410 may manage two computing devices.

FIG. 4 shows a computation of layer 1 of a neural network. In some cases, the computation may be performed using a graph G=(V, E), a node feature, and edge features x⁰ and e⁰ as an input. As shown in FIG. 4, when the computation of the layer 1 begins, the device 2 may be unavailable since the device 2 is processing other tasks. Accordingly, the device pool 410 may inform the apparatus 400 that device 1 is an available device, and the apparatus 400 may transmit a graph to the device 1 without partitioning the graph because there is only one available device.

A node feature x₁¹ and an edge feature e₁¹ may be obtained using the computation results for the layer 1 of the neural network in the device 1 in device pool 410.

Thereafter, the computation may proceed based on inputting a graph including the node feature x¹ and the edge feature e¹ (e.g., received from device 1 of device pool 410) to layer 2 of apparatus 400. The apparatus 400 may identify available resources using the device pool 410. In some cases, while the layer 1 is computed, tasks on the device 2 are completed and the device 2 becomes available. Accordingly, the device 1 and the device 2 may be identified as the available resources.

In some cases, since two available resources are available, the apparatus 400 may partition an edge E into two parts E₁ and E₂ and may form graphs G1=(V, E₁) and G2=(V, E₂). Accordingly, the edge feature e¹ may be partitioned. Each of available resources m=1 and m=2 may compute the layer 2 of the neural network when each partitioned partial graph is provided as an input. The computation results xₘ² and eₘ² may be transmitted to the apparatus 400, and the computation results x² and e² may be obtained based on a combination process (e.g., a joining/composing/reducing computation).

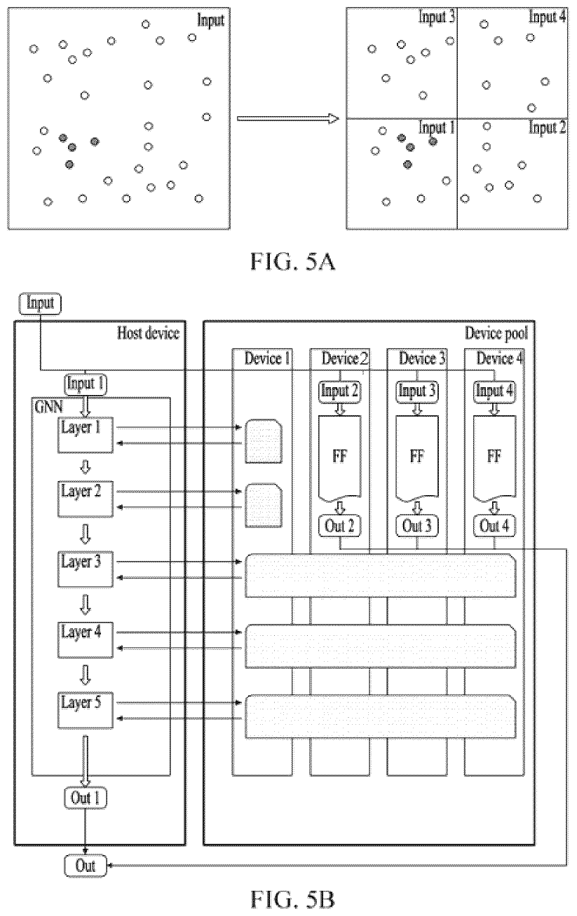

FIGS. 5A and 5B illustrate an example of a molecular dynamics simulation, according to an embodiment.

FIG. 5A is an example of partitioning a space during a simulation and FIG. 5B is an example of a simulation flow.

For example, as shown in FIG. 5A, when a space is partitioned into four spaces, it may be assumed that a molecular dynamics simulation is possible in which an area of input 1 requires a precise computation and is computed with a GNN. Additionally, input 2, input 3, and input 4 compute the force applied to an atom using a classical force field (FF).

A classical force field in the context of molecular modeling and computational chemistry refers to a set of mathematical functions and parameters used to describe the potential energy of a system of atoms or molecules. The force fields are employed to simulate the physical behavior of molecular systems by calculating the forces acting on each atom, which can then be used to predict the structure, dynamics, and thermodynamic properties of the system.

Accordingly, when the molecular dynamics simulation is performed where four computing devices are connected to each other, the molecular dynamics simulation may be performed with a flow shown in FIG. 5B.

In some cases, among four available resources, when tasks of computing the classical FF for the input 2, the input 3, and the input 4 are assigned to device 2, device 3, and device 4, an available resource capable of computing a GNN for the input 1 may be device 1. Accordingly, the layer 1 and the layer 2 may be processed by device 1 until the computation of the classical FF for input 2, input 3, and input 4 is completed in device 2, device 3, and device 4.

When the classical FF for input 2, input 3, and input 4 is completed, device 2, device 3, and device 4 may be used as the available resources. In some cases, layer 3 is a layer computed after classical FF for input 2, input 3, and input 4 is completed. Accordingly, graphs input from a previous layer may be partitioned into four layers and may be computed in parallel via each computing device.

In some cases, even when two GNNs with different amounts of computations or different computational speeds are simultaneously inferred, the computation results may be obtained using the method described herein with reference to FIGS. 1 to 5B in which the available resources are completely used.

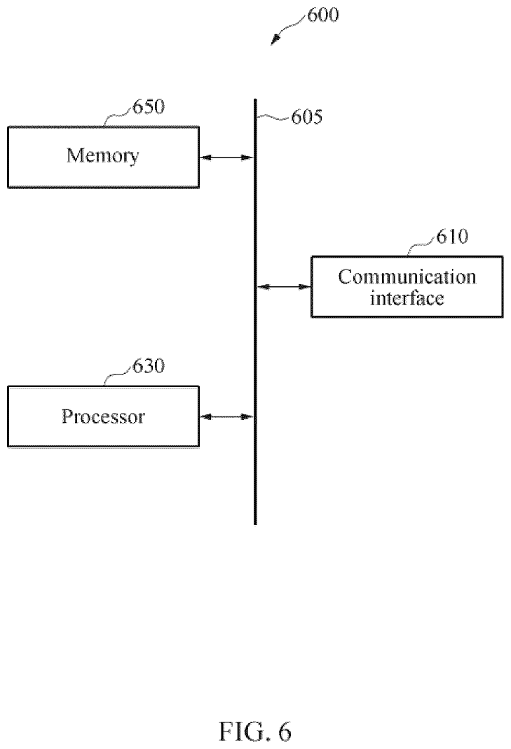

FIG. 6 is a block diagram of an apparatus according to an embodiment.

Referring to FIG. 6, an apparatus 600 according to an embodiment may include a communication interface 610, a processor 630, and a memory 650. The communication interface 610, the processor 630, and the memory 650 may communicate with each other via a communication bus 605.

The communication interface 610 may receive an input graph.

The processor 630 may identify available resources through the communication interface 610. In some cases, the processor 630 may identify available (e.g., idle) resources. In some cases, the processor 630 may perform distributed parallel processing on the input graph by partitioning and assigning the input graph into the identified available resources.

The memory 650 may store a variety of information generated in the processing operation of the processor 630. Additionally, the memory 650 may store various types of data and programs. The memory 650 may include a volatile memory or a non-volatile memory. The memory 650 may include a high-capacity storage medium such as a hard disk to store a variety of data.

Additionally, the processor 630 may perform one or more of the methods described with reference to FIGS. 1 to 5B, or an algorithm corresponding to one or more of the methods. The processor 630 may be a hardware-implemented data processing device having a circuit that is physically structured to execute desired operations. For example, the desired operations may include code or instructions included in a program. The processor 630 may be implemented as, for example, a central processing unit (CPU), a graphics processing unit (GPU), or a neural network processing unit (NPU). The hardware-implemented data processing device may include, for example, a microprocessor, a CPU, a processor core, a multi-core processor, a multiprocessor, an application-specific integrated circuit (ASIC), and a field-programmable gate array (FPGA).

The processor 630 may execute a program and control the apparatus 600. In some cases, processor 630 is configured to operate a memory array using a memory controller. In other cases, a memory controller is integrated into processor 630. In some cases, processor 630 is configured to execute computer-readable instructions stored in memory 650 to perform various functions. In some aspects, processor 630 includes special purpose components for modem processing, baseband processing, digital signal processing, or transmission processing. According to some aspects, processor 630 comprises the one or more processors described herein. Code of the program executed by the processor 630 may be stored in the memory 650.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as CD-ROM discs and/or DVDs; magneto-optical media such as optical discs; and hardware devices that are specially configured to store and perform program instructions, such as read-only memory (ROM), random access memory (RAM), flash memory, and the like.

In some cases, memory 650 includes a basic input/output system (BIOS) that controls basic hardware or software operations, such as an interaction with peripheral components or devices. In some cases, memory 650 includes a memory controller that operates memory cells of memory 650. For example, the memory controller may include a row decoder, column decoder, or both. In some cases, memory cells within memory 650 store information in the form of a logical state.

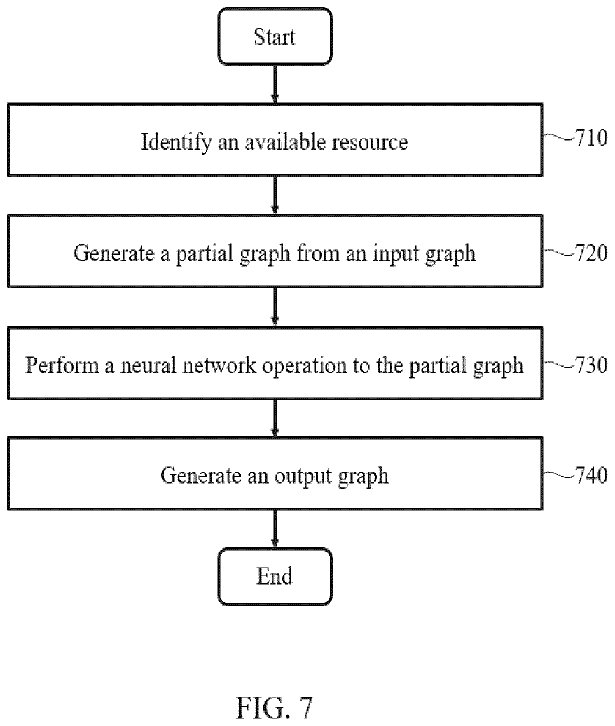

Accordingly, an embodiment of the present disclosure may be configured to perform distributed parallel processing for a layer of a neural network. FIG. 7 illustrates a method of distributed parallel processing.

Operations to be described hereinafter may be performed sequentially but not necessarily. For example, the order of the operations may change and at least two of the operations may be performed in parallel.

An apparatus (hereinafter, referred to as an “apparatus”) may compute a layer of a neural network through operations 710 to 740. The layer computed through operations 710 to 740 may correspond to one of a plurality of layers forming the neural network. As described with reference to FIG. 1, the neural network may correspond to a graph neural network (GNN). Further details regarding each of operations 710-740 are provided with reference to FIGS. 1-5.

At operation 710, the apparatus may identify an available resource (e.g., an idle resource) among a plurality of computing resources.

In some cases, the apparatus may be a host device that manages a device pool including a plurality of computing devices. In some cases, the apparatus may transmit a protocol message for each of the plurality of computing devices. In some cases, the apparatus may transmit the protocol message in a predetermined time period.

According to an embodiment, the apparatus receives a response to the protocol message based on the available resource among the plurality of computing devices. In some cases, the available resource may be identified by the apparatus based on the response received from the plurality of computing devices.

At operation 720, the apparatus generates a partial graph from an input graph based on the available resource. In some cases, after the determination of the available resource among the plurality of computing devices, the apparatus may skip a partitioning process of the input graph. Accordingly, the partial graph may be same as the input graph. For example, the input graph may be transmitted to the available resource as the partial graph without performing a partition process. Further details regarding this operation are provided with reference to FIGS. 1 and 5.

At operation 730, the available resource performs a neural network operation on the partial graph to obtain an updated partial graph. In some cases, the available resource may process the assigned partial graph according to the specifications of the available resource and may transmit (e.g., re-transmit) the processing result to the apparatus.

At operation 740, the apparatus generates an output graph based on the updated partial graph. In some examples, the apparatus generates an output graph corresponding to the graph neural network.

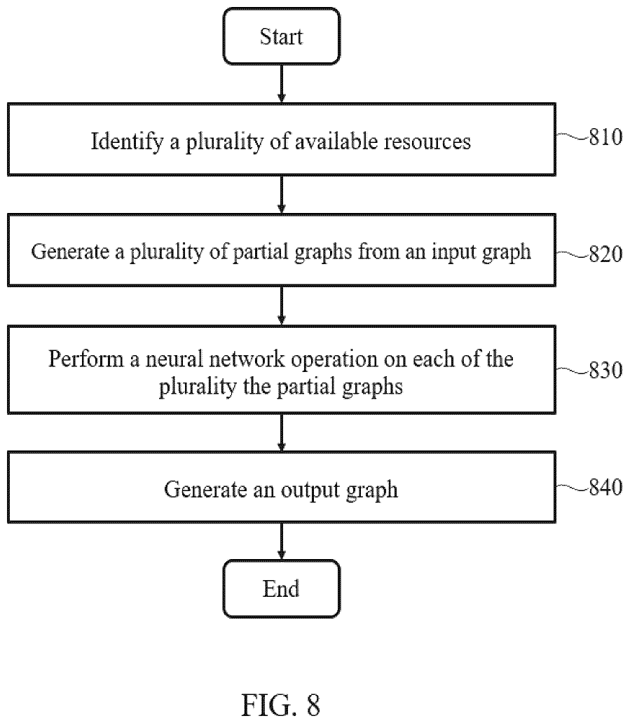

Additionally, an embodiment of the present disclosure may be configured to perform distributed parallel processing for a layer of a neural network. FIG. 8 illustrates a method of distributed parallel processing based on a plurality of available resources.

At operation 810, the apparatus identifies a plurality of available resources among a plurality of computing resources.

In some cases, the apparatus may manage a device pool including a plurality of computing devices. In some cases, the apparatus may transmit a protocol message for each of the plurality of computing devices. In some cases, the apparatus may transmit the protocol message in a predetermined time period.

According to an exemplary embodiment, the apparatus receives a response to the protocol message based on the available resources among the plurality of computing devices. In some cases, the available resources may be identified by the apparatus based on the response received from the plurality of computing devices.

At operation 820, the apparatus generates a plurality of partial graphs from an input graph based on the plurality of available resources.

In some cases, after the determination of the number of available resources among the plurality of computing devices, the apparatus may partition the input graph to obtain the partial graph. For example, the input graph may be partitioned by randomly selecting edges according to the number of available resources. In some examples, the input graph may be partitioned around the same node in the input graph to generate a partial graph. In some examples, the apparatus may partition the input graph around a space (e.g., a node) when there is spatial information in a node. Further details regarding this operation are provided with reference to FIGS. 1-2 and 5.

At operation 830, the apparatus performs a neural network operation on each of the plurality of partial graphs using a corresponding available resource among the plurality of available resources, respectively, to obtain a plurality of updated partial graphs. In some cases, the available resource may process the plurality of partial graphs according to the specifications of the available resource and may transmit (i.e., re-transmit) the processing result to the apparatus.

At operation 840, the apparatus generates an output graph based on the plurality of updated partial graphs. In some examples, the apparatus generates an output graph corresponding to the graph neural network.

Examples of program instructions include both machine code, such as produced by a compiler, and files containing higher-level code that may be executed by the computer using an interpreter. The devices described above may be configured to act as one or more software modules in order to perform the operations of the examples, or vice versa.

The software may include a computer program, a piece of code, an instruction, or some combination thereof, to independently or uniformly instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network-coupled computer systems so that the software is stored and executed in a distributed fashion. The software and data may be stored by one or more non-transitory computer readable recording mediums.

While the embodiments are described with reference to drawings, it will be apparent to one of ordinary skill in the art that various alterations and modifications in form and details may be made in these embodiments without departing from the spirit and scope of the claims and their equivalents. For example, suitable results may be achieved if the described techniques are performed in a different order, and/or if components in a described system, architecture, device, or circuit are combined in a different manner, or replaced or supplemented by other components or their equivalents.

The processes discussed above are intended to be illustrative and not limiting. One skilled in the art would appreciate that the steps of the processes discussed herein may be omitted, modified, combined, and/or rearranged, and any additional steps may be performed without departing from the scope of the invention. More generally, the above disclosure is meant to be exemplary and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted, the systems and/or methods described above may be applied to, or used in accordance with, other systems and/or methods.

Therefore, other implementations, other embodiments, and equivalents to the claims are also within the scope of the following claims.

What is claimed is:

1. A method of distributed parallel processing, the method comprising:
identifying an available resource among a plurality of computing resources;
generating a partial graph from an input graph based on the available resource;
performing, using the available resource, a neural network operation to the partial graph to obtain an updated partial graph; and
generating an output graph based on the updated partial graph.

2. The method of claim 1, wherein the identifying the available resource comprises:
transmitting a protocol message for each of the plurality of computing resources in a predetermined time period;
receiving a response to the protocol message corresponding to the available resource, wherein the available resource is identified based on the response.

3. The method of claim 1, wherein generating the partial graph comprises:
determining a number of available resources among the plurality of computing resources; and
partitioning the input graph based on the number of available resources to obtain the partial graph.

4. The method of claim 3, wherein the input graph is partitioned into a plurality of partial graphs around a same node of the input graph.

5. The method of claim 3, wherein the input graph is partitioned in a simulation space.

6. The method of claim 1, wherein generating the partial graph comprises:
determining a processing speed of the available resource, wherein the partial graph is generated based on the processing speed.

7. The method of claim 1, wherein generating the output graph comprises combining a plurality of partial graphs to obtain the output graph.

8. The method of claim 1, further comprising:
identifying a subsequent available resource among the plurality of computing resources; and
generating a subsequent partial graph from the output graph based on the subsequent available resource.

9. The method of claim 1, wherein the neural network operation comprises a graph neural network (GNN) operation.

10. A non-transitory computer-readable storage medium storing instructions that, when executed by a processor, cause the processor to perform the method of claim 1.

11. An apparatus for distributed parallel processing for a layer of a neural network, the apparatus comprising:
one or more processors;
a memory; and
one or more programs stored in the memory and configured to be executed by the one or more processors,
wherein the one or more programs are configured to:
identify an available resource among a plurality of computing resources;
generate a partial graph from an input graph based on the available resource;
perform, using the available resource, a neural network operation to the partial graph to obtain an updated partial graph; and
generate an output graph based on the updated partial graph.

12. The apparatus of claim 11, wherein the one or more programs are configured to:
transmit a protocol message for each of the plurality of computing resources in a predetermined time period; and
receive a response to the protocol message corresponding to the available resource, wherein the available resource is identified based on the response.

13. The apparatus of claim 11, wherein the one or more programs are configured to:
determine a number of available resources among the plurality of computing resources; and
partition the input graph based on the number of available resources to obtain the partial graph.

14. The apparatus of claim 13, wherein the one or more programs are configured to partition the input graph into a plurality of partial graphs around a same node of the input graph.

15. The apparatus of claim 13, wherein the input graph is partitioned in a simulation space.

16. The apparatus of claim 11, wherein the one or more programs are configured to:
determine a processing speed of the available resource, wherein the partial graph is generated based on the processing speed.

17. The apparatus of claim 11, wherein the one or more programs are configured to combine a plurality of partial graphs to obtain the output graph.

18. The apparatus of claim 11, the one or more programs are further configured to:
identify a subsequent available resource among the plurality of computing resources; and
generate a subsequent partial graph from the output graph based on the subsequent available resource.

19. The apparatus of claim 11, wherein the neural network operation comprises a graph neural network (GNN) operation.

20. A method comprising:
identifying a plurality of available resources among a plurality of computing resources;
generating a plurality of partial graphs from an input graph based on the plurality of available resources;
performing a neural network operation on each of the plurality of partial graphs using a corresponding available resource among the plurality of available resources, respectively, to obtain a plurality of updated partial graphs; and
generating an output graph based on the plurality of updated partial graphs.

21. The method of claim 20, further comprising:
identifying a subsequent plurality of available resources among the plurality of computing resources, wherein a number of the subsequent plurality of available resources is different from a number of plurality of available resources;
generating a subsequent plurality of partial graphs corresponding to the subsequent plurality of available resources based on the output graph, wherein a number of the subsequent plurality of partial graphs is different from a number of the plurality of partial graphs.
